(19) United States
(12) Patent Application Publication
(10) Pub. No.: US 2026/0128399 A1
(43) Pub. Date: May 7, 2026

(54) Battery With Internal Monitor And Display

(71) Applicant: Systematic Power Solutions, LLC, Knoxville, TN (US)

(72) Inventors: Kevin J. Bennett, Corryton, TN (US); Alan J. Testani, Boca Raton, FL (US)

(73) Assignee: Systematic Power Solutions, LLC, Knoxville, TN (US)

(21) Appl. No.: 19/048,189

(22) PCT Filed: Sep. 29, 2023
(86) PCT No.: PCT/US2023/075533

§ 371 Date: Feb. 7, 2025

Related U.S. Application Data
(60) Provisional application No. 63/411,261, filed on Sep. 29, 2022.

(51) Int. Cl. H01M 10/48; H01M 10/42; H01M 50/24; H01M 50/249; H02J 7/56; H02J 7/96

(52) U.S. Cl. CPC H01M 10/482; H01M 10/425; H01M 10/488; H01M 50/24; H01M 50/249; H02J 7/56; H02J 7/96; H01M 2010/4271; H01M 2010/4278; H01M 2220/20

(57) ABSTRACT

A battery for marine applications includes multiple battery cells, a sense module, a communications module, a network interface, and a battery management system, all disposed within a watertight housing. The sense module includes circuitry for generating battery status information indicative of the status of the battery cells. The communications module receives the battery status information and transmits network communication data containing the battery status information. The network interface is configured to connect directly to a standard NMEA 2000 network connector and communicate the battery status information via the standard NMEA 2000 network connector to an NMEA 2000 network. The battery management system measures the voltage of each battery cell and determines a voltage difference between a lowest-voltage cell and a highest-voltage cell and balances the charging of the plurality of battery cells to maintain the voltage difference at less than a predetermined maximum value.

### STATEMENT OF RELATED APPLICATIONS

The present application is filed as a U.S. National Phase patent application under 35 U.S.C. § 371. The application claims priority to PCT/US2023/075533 filed Sep. 29, 2023. That application was titled “Battery With Internal Monitor and Display.”

The International Patent Application claimed the benefit of U.S. Provisional Patent Application No. 63/411,261 filed Sep. 29, 2022.

Each of these prior applications is incorporated herein in its entirety by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Technical Field of the Invention

This invention relates to the field of mobile electrical power sources. More particularly, this invention relates to a battery for marine applications.

### Discussion of the Background

NMEA 2000, also referred to as N2K, is a plug-and play communications standard used for connecting marine sensors and display units within marine vehicles. Devices that use the NMEA 2000 protocol can communicate with any other NMEA 2000 compatible sensor, display unit or other device on a communication network. NMEA 2000 is electrically compatible with the Controller Area Network (CAN) communication protocol used on road vehicles. NMEA 2000 can be used to create a network of electronic marine instruments and devices via one central backbone cable that provides power to and relays data between all of the devices on the network. This allows one display unit on the network to display information from many different types of marine devices.

Prior marine batteries have included network interfaces for communicating battery status information. However, those batteries have proprietary interface connections on their housings that require a separate proprietary interface device-such as an adaptor or gateway unit-to be able to electrically connect the battery to the NMEA 2000 network in a boat. Without the separate proprietary interface device, such prior batteries are unable to communicate with other marine devices over an NMEA 2000 network.

What is needed, therefore, is a battery that can communicate battery status information directly to an NMEA 2000 network through an NMEA 2000 interface port provided on the battery's housing, thereby eliminating the need for a separate proprietary interface device.

### SUMMARY OF THE INVENTION

The above and other needs are met by a battery for marine applications. The battery includes a sealed watertight housing containing battery cells, an internal battery management system, a full-function, internal battery monitoring system, a communications system for reporting data directly to an NMEA 2000 network, and an OLED display. In one preferred embodiment, the battery cells are Lithium Iron Phosphate (LFP) lithium-ion cells. Alternatively, the battery cells may be Sodium-ion, Lithium-ion, or other battery chemistry cells. However, the battery is not limited to LFP cells, as other types of battery chemistries could be implemented in other embodiments. LFP battery cells provide:
three times the energy density of comparable lead acid batteries;
vibration dampening to endure abusive high-vibration and G-shock environments;
the ability to charge up to five times faster than lead-acid batteries;
five times the charge cycle life of lead-acid batteries at 80% DoD (depth of discharge), providing more than 2,500 charge cycles;
96% efficiency at converting input energy into stored energy (compared to approximately 75% for lead-acid batteries), which is advantageous in solar applications and when recharging from a generator; and
a self-discharge rate of less than 2% per month (compared to about 5-8% per month for lead-acid batteries).

The battery is designed for inductive loads, such as trolling motors, and is also capable of engine start applications. The battery features high-power cells and a high-current battery management system (BMS) designed for repeated pulse loading and alternator charging. The battery is also capable of dampening voltage transients.

One point of novelty of the system described herein is that it provides a direct network connection between the battery and the NMEA 2000 network, so that battery status can be reported over the network without external boxes, gateways or adaptors needed between the battery and the NMEA 2000 network. A second point of novelty is that the system provides a battery monitor that is electrically outside the BMS but physically inside the battery. In this respect, the battery monitor is agnostic, in that it can function with any BMS. The battery monitor can function with an advanced BMS by simply formatting and reporting the battery data or it can monitor and develop the data when paired with a simple BMS that does not have reporting capabilities.

Preferred embodiments described herein are directed to a battery for marine applications. The battery comprises a watertight housing and multiple battery cells, a sense module, a communications module, and a network interface all disposed within the watertight housing. The sense module, which is in electrical communication with the battery cells, includes circuitry for generating battery status information indicative of the status of the battery cells. The communications module, which is in electrical communication with the sense module, receives the battery status information and transmits network communication data containing the battery status information. The network interface, which is in electrical communication with the communications module, is configured to connect directly to a standard NMEA 2000 network connector and communicate the battery status information via the standard NMEA 2000 network connector directly to an NMEA 2000 network.

In some embodiments, the battery includes a battery management system disposed within the housing and in electrical communication with the plurality of battery cells. The battery management system is configured to measure the voltage of each battery cell and determine a voltage difference between a lowest-voltage cell and a highest-voltage cell, and to balance the charging and discharging of the battery cells to maintain the voltage difference at less than a predetermined maximum value.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein;

FIG. 1 depicts a functional block diagram of a battery according to an embodiment of the invention. The diagram reveals components inside the battery, including a battery management system.

FIG. 2 depicts a top perspective view of the battery of FIG. 1 according to an embodiment of the invention.

FIG. 3 depicts top plan view of the battery according to an embodiment of the present disclosure.

FIGS. 4A and 4B depict views of the layout of internal components of the battery of FIG. 1 according to an embodiment of the invention.

FIG. 5 depicts a button assembly and status LEDs according to an embodiment of the invention.

FIG. 6 depicts a state-of-charge (SoC) indicator LED according to an embodiment of the invention.

### DEFINITIONS

Reference herein to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment.

### DETAILED DESCRIPTION OF CERTAIN EMBODIMENTS

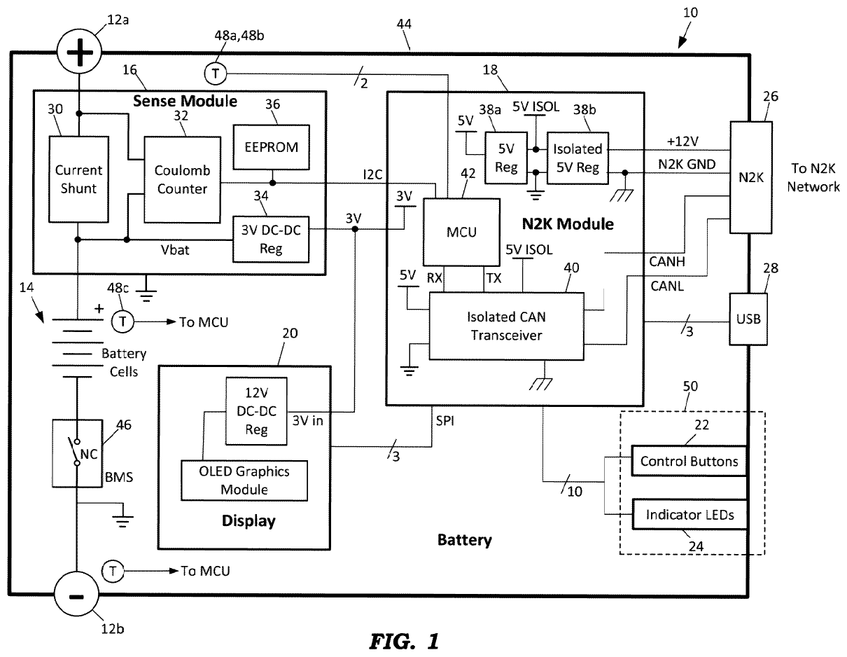

FIG. 1 presents a functional block diagram of a battery 10 according to an embodiment of the invention. The schematic view reveals components inside the battery 10. The battery 10 is designed for inductive loads, such as trolling motors. Of course, the battery is also capable of providing engine starts, such as for an internal combustion engine on a boat. The battery 10 features high-power cells 14 and a high-current battery management system (BMS) 46. The battery 10 is designed for repeated pulse loading and alternator charging. The battery 10 is also capable of dampening voltage transients.

The battery 10 first comprises a shell, or housing 44. The housing 44 securely holds internal components of the battery 10 such as the BMS 46. Of importance for marine applications, the housing 44 provides a sealed, watertight housing for a plurality of battery cells 14.

The housing 44 supports a positive terminal 12a and a negative terminal 12b. The terminals 12a, 12b are at least partially external to the housing 44.

An optional OLED display 20 is provided on the housing 44. The OLED display 20 may include a graphics module (not numbered but indicated within Block 20) and a 12V DC-DC regulator (also not numbered but indicated within Block 20). A USB port 28 may also be provided on the housing 110. The USB port 28 is useful for firmware upgrades.

As noted, the battery 10 also includes a battery management system (BMS) 46. In the case where multiple cells are employed within the battery 14, the BMS 46 protects and balances the battery cells. Cell balancing involves measuring the voltage in each cell and using the voltage data to monitor the voltage Delta (ΔV), which is the difference in measured voltage between the lowest-voltage cell and the highest-voltage cell. The cell balancing is intelligent, and continues to balance the cells 14 to operate within a factory pre-set maximum (ΔV). In this way, the BMS 46 also serves as a safety system to ensure the cells 14 are maintained within their safe window of operation.

The battery 10 of FIG. 1 also includes a sense module 16. The sense module 16 includes a current shunt 30 for monitoring energy flow into or out of the battery cells 14. The sense module 16 may also include a coulomb counter 32 for estimating the state of charge (SoC) of the cells 14, and a 3V DC-DC voltage regulator 34. In addition, the sense module 16 may have an EEPROM 36.

The sense module 16 resides electrically between the battery 14 and one of the terminals 12a, 12b. In the arrangement of FIG. 1, the sense module 16 resides between the battery 14 and the positive terminal 12a.

The battery 10 also includes an NMEA 2000 Module 18. This may be referred to as a communications module, or as an N2K Module 18. The NMEA 2000 Module 18 is a plug-and-play communications standard used for connecting marine sensors and display units within marine vehicles. Devices that use the NMEA 2000 protocol can communicate with any other NMEA 2000 compatible sensor, display unit, or other device on a communications network.

Beneficially, NMEA 2000 Module 18 is electrically compatible with the Controller Area Network (CAN) communication protocol used on road vehicles. NMEA2000 communications systems can be used to create a network of electronic marine instruments and devices via one central backbone cable that provides power to and relays data between all of the devices on the network. This allows one display unit on the network to display information from many different types of marine devices.

The NMEA 2000 Module 18 includes 5V voltage regulators 38a, 38b. The Module 18 also has an isolated CAN transceiver 40, and a controller 42. The controller 42 may be an ARM Cortex Micro-Control Unit (MCU).

As depicted in FIG. 1, the NMEA 2000 Module 18 communicates with an NMEA 2000 micro-port interface 26. Together, the NMEA 2000 Module 18 and the NMEA 2000 micro-port interface 26 provide a direct connection to an NMEA 2000 network within the boat or other vehicle in which the battery 14 is installed. This provides a distinct advantage over prior battery systems that require a separate proprietary interface unit between a battery and the NMEA 2000 network.

The battery 10 of FIG. 1 also includes a membrane control assembly 50. The membrane control assembly 50 includes control buttons 22 and status indicator LED's 24.

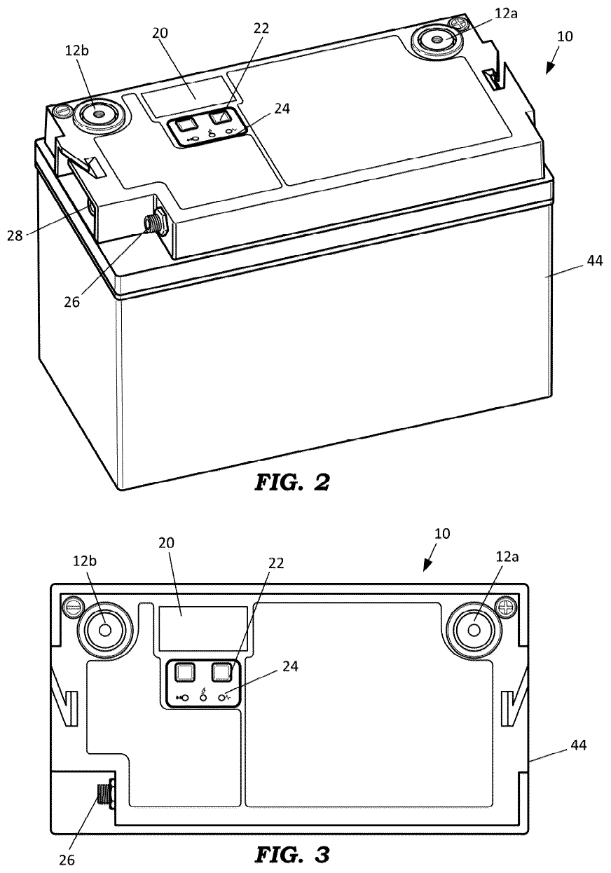

FIG. 2 depicts a top perspective view of the battery 10 of FIG. 1, in one aspect.

FIG. 3 depicts a top plan view of the battery 10 of FIG. 2.

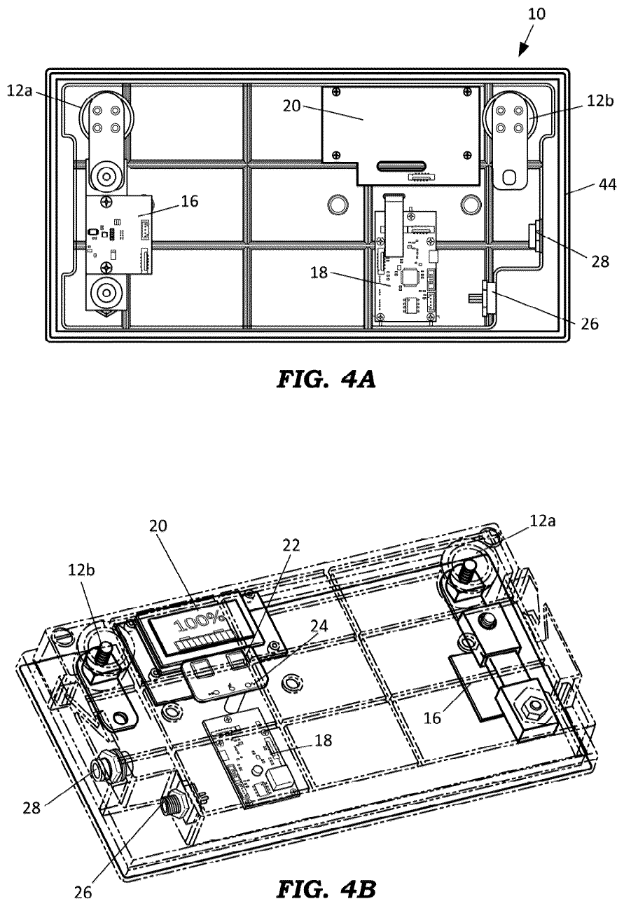

FIGS. 4A and 4B depict views of the layout of internal components of the battery 10 of FIG. 1, according to an embodiment of the invention.

As shown in FIGS. 2, 3, 4A and 4B, battery components that are at least partially external to the battery housing 44 include the positive and negative battery terminals 12a, 12b, the OLED display 20, the membrane control assembly 50, the USB port 28 and the NMEA 2000 interface 26.

A preferred embodiment of the battery monitoring system of the battery 10 is scalable and can function with BMS systems having various levels of functionality. When working with a “genius” BMS system, the sense module of the battery monitor system only reports information. When working with a “smart” BMS system, the BMS system reports some information to the battery monitor, while the battery monitoring system develops the rest of the information. The third level of BMS functionality (or PCM) is basic, and the battery monitor system develops all the information and reports it over the NMEA 2000 interface 26.

The BMS 46 also serves as a safety system to ensure the cells are always kept inside their safe window of operation. In this regard, the BMS 46 provides monitoring and protection for cell level over-voltage, cell level under-voltage, pack level over-current, short circuit, over-temperature, and under-temperature. If any out-of-range condition develops, the BMS 46 interrupts the flow of current as needed.

If any of the cells 14 reaches an out-of-range voltage, the BMS 46 shuts down the entire battery 10. If the shutdown was due to high voltage in one or more cells 14 during charging, the BMS 46 automatically resets when the out-of-range cell's voltage comes back down to within its factory pre-set voltage, typically within five minutes after the charge voltage is removed. If the shutdown was due to low voltage in one or more of the cells 14, the BMS 46 automatically resets when a charger is connected. Such a low-voltage condition typically means that the cell-or perhaps the entire battery-is deeply discharged.

The BMS 46 also includes overcurrent protection and short circuit protection. Overcurrent, either during charging or discharging, trips the overcurrent protection. The system automatically resets after all the cables and wires are disconnected from the ground terminal on the battery 10 for at least 10 seconds and then reconnected.

With regard to thermal protection, in the event the battery's internal temperature exceeds preset high or low limits, the BMS 46 shuts down the battery 120. The system automatically resets when the temperature of the battery is back within an acceptable range.

In a preferred embodiment, NMEA 2000 module 18 uses signals from the coulomb counter 32 with Peukert exponent and temperature measurements in capacity/time calculations. The temperature measurements are based on signals from three thermistors 48a, 48b, 48c: near the positive terminal 12a, near the negative terminal 12b and near the battery cells 14. The NMEA 2000 module 18 is NMEA 2000 certified, directly addressable on a NMEA 2000 network, and is compatible with all NMA 2000 multi-function displays. The BMS 46 reports all required alerts in Parameter Group Number (PGN) format as well as standard battery related PGN alerts (127506, 127508, 127513, 126983). Through the NMEA 2000 interface 26, the NMEA 200 module 18 puts individual battery voltage, current, time remaining, state of charge, amp-hours consumed, and temperatures of the cells 14 and terminals 12a, 12b on the network in the prescribed PGN formats. The NMEA 2000 module 18 records warnings and alert events with a real time/date stamp, and records cumulative lifetime amp-hours, all of which is viewable on the optional OLED display 20. The NMEA 2000 module 18 operates with firmware that can be field updated using the USB port 28.

The NMEA 2000 module 18 provides a precise SoC indication in any given condition, while idling or charging or discharging. During normal cycling of the battery 10, the NMEA 2000 module 18 monitors some significant points in the SoC. For example, when the battery voltage rises to a predetermined level and remains there while the amperage falls to a predetermined level, the NMEA 2000 module 18 will “Sync,” meaning that it will assume the battery 10 is at 100% SoC. At this point, the NMEA 2000 module 18 updates the “Lifetime Ah”, updates the SoC to 100%, and updates “Charge Used” to 0.0Ah. When the battery 10 is discharging, the NMEA 2000 module 18 shows the percent SoC, charge used, and time remaining. Once the battery 10 reaches 10% SoC, a flashing alert is activated. When the battery 10 drops to 0% SoC, alerts are generated, an alarm log entry is made, the red alarm LED 24 flashed, and the word “**LO**” appears above the battery icon on the display screen 20.

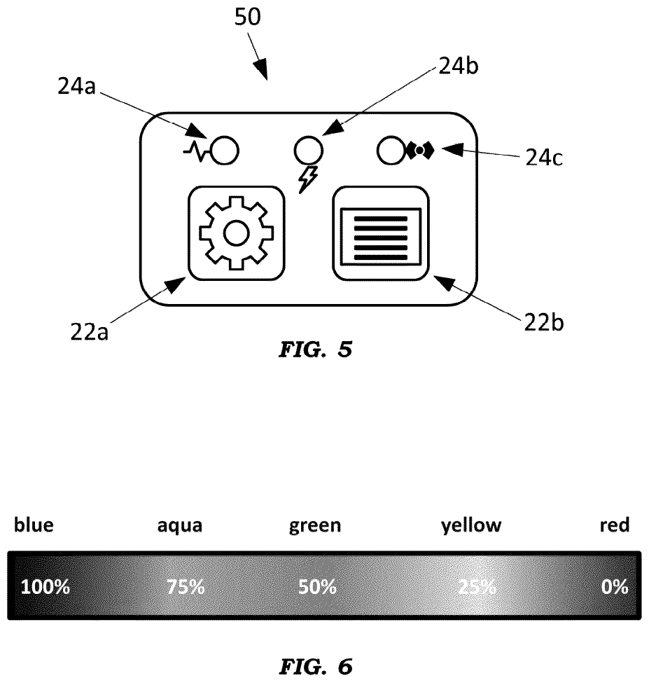

In a preferred embodiment depicted in FIG. 5, the NMEA 2000 module 18 is controlled using the membrane control assembly 50 that includes three LEDs 24 and two buttons 22. The LEDs include an Activity LED 24a, an SoC LED 24b, and an Alarm/Warning LED 24c, and the buttons include a setup button 22a and a display button 22b.

The Activity LED 24a has the following behavior based on certain events:
Very rapid flash when any NMEA 2000 PGN is sent or received;
Flashes on during NMEA 2000 initialization and address claiming (i.e., when the NMEA 2000 cable is attached);
Solid on while synching, and five short flashes when complete;
Solid on after Restart/Reset initiated, and turns off when restart is complete;
During Zero Calibration, flashes for every data sample taken, and one long flash if the calibration is successful, and rapidly flashes for five seconds if a calibration failure occurs.

The SoC LED 24b changes color according to the SoC, as shown in FIG. 6. In a preferred embodiment, this LED 24b is only on for a short period of time when the display button 22b is pushed, and it will come on solid if the SoC is less than 25%. The Alarm/Warming LED 24c slowly blinks (such as one second on, one second off) if any alarm is triggered, and rapidly blinks if a warming or alarm is active and stops blinking if no warning or alarms are active.

With reference to FIG. 5, repeatedly pressing the display button 22b toggles through various screens on the display 20, such as in the following order:
Splash screen (logo and www.lithiumpros.com) displays for two seconds on MCU reset, but not in rotation;
Logo, website, battery model and type screen;
Battery information screen including Lifetime Ah cycled;
NMEA 2000 information, if connected;
Alarm log (only displayed if an alarm has occurred);
Warning log (only displayed if a warning has occurred);
SoC (including a factory-determined reserve, which means there is still an undetermined reserve in the battery before BMS shutdown when 0% id displayed);
Time remaining in hours (displays “>24 hr” if time remaining is over 24 hours at this amperage load and “Charging” if the amperage is positive.);
Current (+/−) or amperage (positive value if the battery is charging and a negative value if it is discharging);
Charge used (Ah) (actual amp-hours of energy removed from the battery since the last charge, will indicate 0.0 when the battery is full);
Volts (V);
Internal temperature (F/C) or cell temperature (selectable in either Fahrenheit or Celsius); and
Terminal temperature (F/C), which is max of either the positive or negative terminal (selectable in either Fahrenheit or Celsius).

The setup button 22a is used to select functions to be executed by pressing the button various lengths of time. All timed buttons operate when the setup button 22a is released. If the SoC is >98%, the SoC may be manually set to 100% (i.e., “Synced”) by pressing and holding the setup button 22a for more than 5 seconds and less than 10 seconds (e.g., 7 seconds). When the setup button 22a is released, the Activity LED 24a illuminates solid while the sync operation is in process. Upon successful sync, the Activity LED 24a flashes five times. The OLED display 20 can be rotated 180 degrees for easier viewing by pressing and holding the setup button 22a for more than 10 seconds and less than 15 seconds (e.g., 12 seconds). When the setup button 22a is released, the message “Display flipped” flashes and then returns to the normal display. The OLED display 20 can display temperature in either Fahrenheit or Celsius, which can be toggled pressing and holding the setup button 22a for more than 15 seconds and less than 20 seconds (e.g., 17 seconds). When the setup button 22a is released, the setting returns to the normal display mode. The BMS 46 can be restarted by pressing and holding the setup button 22a for more than 30 seconds and then releasing. When the setup button 22a is released, the Activity LED 24a goes solid and then off, and the restart commences.

The foregoing description of preferred embodiments for this invention have been presented for purposes of illustration and description. They are not intended to be exhaustive or to limit the invention to the precise form disclosed. Variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

1. A battery for marine applications, the battery comprising:
a watertight housing;
a plurality of battery cells disposed within the housing;
a sense module disposed within the housing and in electrical communication with the plurality of battery cells, the sense module including circuitry configured for generating battery status information indicative of the status of the battery cells;
a communications module disposed within the housing and in electrical communication with the sense module, the communications module configured to receive the battery status information and then transmit network communication data containing the battery status information; and
a network interface disposed within the housing and in electrical communication with the communications module, the network interface configured to connect directly to a standard NMEA 2000 network connector and communicate the battery status information via the standard NMEA 2000 network connector directly to an NMEA 2000 network.

2. The battery of claim 1, further comprising:
a battery management system disposed within the housing and in electrical communication with the plurality of battery cells, the battery management system configured to measure the voltage of each battery cell, and determine a voltage difference (ΔV) between a lowest-voltage cell and a highest-voltage cell, and to balance charging and discharging of the plurality of battery cells to maintain (ΔV) at less than a predetermined maximum value.

3. The battery of claim 2, has further comprising:
circuity for accepting data from a battery management system having functionality to output coulomb data.

4. The battery of claim 3, wherein the circuit comprises a current shunt connected to a coulomb counter for measuring coulombs.

5. The battery of claim 2, further comprising:
an OLED display for displaying the battery status information.

6. The battery of claim 5, further comprising:
a data interface for outputting battery status information wirelessly or via a wired NMEA 2000 network connector.

7. The battery of claim 1, wherein the battery cells comprise Sodium-ion or Lithium-ion, cells.
